(19) United States
(12) Patent Application Publication
(10) Pub. No.: US 2017/0215114 A1
(43) Pub. Date: Jul. 27, 2017

(54) D2D COMMUNICATION TERMINAL AND ASSOCIATED COMMUNICATION METHOD

(71) Applicant: SHARP KABUSHIKI KAISHA, Sakai City, Osaka (JP)

(72) Inventors: Bo LI, Shanghai (CN); Qi JIANG, Shanghai (CN); Renmao LIU, Shanghai (CN)

(73) Assignee: SHARP KABUSHIKI KAISHA, Sakai City, Osaka (JP)

(21) Appl. No.: 15/326,874

(22) PCT Filed: Jul. 16, 2015
(86) PCT No.: PCT/CN2015/084206

§ 371 Date: Jan. 17, 2017

(30) Foreign Application Priority Data
Jul. 18, 2014 (CN) 201410345267.4

(51) Int. Cl. H04W 36/00; H04W 76/06; H04W 76/02; H04W 72/12

(52) U.S. Cl. CPC H04W 36/0072; H04W 72/1215; H04W 76/06; H04W 76/023

(57) ABSTRACT

The present disclosure provides a resource release and reuse mechanism while switching between Mode 1 and Mode 2 in a D2D communication system. According to an embodiment of the present disclosure, a method comprises: detecting a network condition during a D2D Mode 1 transmission and reporting the detected network condition to a base station to assist the base station in timely releasing physical resources scheduled for the terminal when the transmission is interrupted; and holding data scheduled to transmit in the interrupted transmission in response to the detected network condition satisfying a triggering condition of data reception interruption, and switching from Mode 1 to Mode 2 for transmitting the held data in Mode 2; or waiting for re-accessing an original cell and returning to Mode 1 for transmitting the held data in Mode 1. With the method according to the present disclosure, the resource utilization in the D2D communication system can be improved and a better network performance gain can be achieved.

### TECHNICAL FIELD

The present disclosure relates to Device-to-Device (D2D) communications, and more particularly, to a resource release and reuse mechanism while switching between Mode 1 and Mode 2 in a D2D communication system.

### BACKGROUND

The D2D technique refers to a communication scheme in which two peer user nodes communicate directly with each other. The D2D technique has critical applications in many areas that have not been standardized by 3GPP, including Peer to Peer (P2P) in a non-cellular operation mode, Ad hoc, which has been continuously studied academically in recent years, as well as Machine to Machine (M2M) in Internet of Things (IoT), which has always been a killer application having tremendous potential service demands. In a centralized or distributed network consisting of D2D user nodes, each user node can transmit and receiving signals and may have an automatic routing (message forwarding) function. Physical resources for carrying their transmissions can be configured by the network, or can be contended for by the respective D2D terminals. It is an innovative concept for User Equipments (UEs) in a cellular system to communicate with each other directly, without relaying by a base station. Obviously, due to natural attenuation characteristics of mobile propagation environments and lower transmitting antennas of UEs, two UEs communicating directly with each other have a relatively small interference area. In this scenario, UEs having sufficient physical isolation (e.g., signal attenuation level) can share the same resources (e.g., space, time, frequency and code resources) without severely interfering with each other. Intuitively, there can be a considerable number of UEs in each cell that can communicate with each other directly. With the introduction of the D2D technique in the cellular network, the spatial multiplexing efficiency of system resources can be improved significantly, such that the load for scheduling network resources can be greatly relieved. Meanwhile, these D2D services are provided in accordance with configuration by the network. It is not only an effective supplement for utilizing air interface resources of existing cellular systems more efficiently, but also capable of accommodating various physical devices into this connection system, such that it is possible to implement IoT and Internet of Vehicles (IoV) in the framework of 3GPP cellular networks. Further, cellular services are only possible in regions having coverage of cellular networks. In regions having no network coverage, D2D communication services can be deployed independently without assistance of base stations, which provides an effective solution for timely rescue in disaster regions (e.g., where networks have been completely available due to earthquake or flood) and is thus a very useful supplement to the existing cellular services. In light of the above, the 3GPP has been working on standardization of D2D. In the RAN1 meeting #72 in Malta in early 2013, the 3GPP has decided to make researches on the D2D technique. In the RAN meeting #63 in Fukuoka in March, 2014, the working item for standardization of D2D services in LTE Rel-12 has been agreed. The LTE Rel-12 standard will support D2D services. The D2D communication requires different D2D transmission modes in different network coverage situations. For example, a D2D communication mode with network scheduling and control, i.e., Mode 1, is typically adopted within network coverage, whereas a D2D communication mode without network scheduling and control, i.e., Mode 2, is adopted in condition of no network coverage. When the network coverage condition or the network signal strength changes, the D2D communication mode may be switched. For example, when the network coverage condition or the network signal strength degrades, the D2D communication mode may be switched from Mode 1 to Mode 2. If resources occupied by a transmission interrupted due to switching of the D2D mode cannot be released timely, there would be a waste of resources. It can be seen from Table 1-1 and Table 1-2 below (corresponding to Table 6.1.3.1-1 and Table 6.1.3.1-2 in 3GPP TS 36.321, respectively), when the size of the buffer of data scheduled to transmit in Buffer State Report (BSR) is very large, or when one transmission period scheduled for D2D is very long, there could be a large amount of transmission resources that would not be released or utilized as a result of transmission interruption due to switching of the D2D mode.

TABLE 1-1
BSR Buffer Size Level

| Index | BS value [bytes] |
|---|---|
| 0 | BS = 0 |
| 1 | 0 < BS <= 10 |
| 2 | 10 < BS <= 12 |
| 3 | 12 < BS <= 14 |
| 4 | 14 < BS <= 17 |
| 5 | 17 < BS <= 19 |
| 6 | 19 < BS <= 22 |
| 7 | 22 < BS <= 26 |
| 8 | 26 < BS <= 31 |
| 9 | 31 < BS <= 36 |
| 10 | 36 < BS <= 42 |
| 11 | 42 < BS <= 49 |
| 12 | 49 < BS <= 57 |
| 13 | 57 < BS <= 67 |
| 14 | 67 < BS <= 78 |
| 15 | 78 < BS <= 91 |
| 16 | 91 < BS <= 107 |
| 17 | 107 < BS <= 125 |
| 18 | 125 < BS <= 146 |
| 19 | 146 < BS <= 171 |
| 20 | 171 < BS <= 200 |
| 21 | 200 < BS <= 234 |
| 22 | 234 < BS <= 274 |
| 23 | 274 < BS <= 321 |
| 24 | 321 < BS <= 376 |
| 25 | 376 < BS <= 440 |
| 26 | 440 < BS <= 515 |
| 27 | 515 < BS <= 603 |
| 28 | 603 < BS <= 706 |
| 29 | 706 < BS <= 826 |
| 30 | 826 < BS <= 967 |
| 31 | 967 < BS <= 1132 |
| 32 | 1132 < BS <= 1326 |
| 33 | 1326 < BS <= 1552 |
| 34 | 1552 < BS <= 1817 |
| 35 | 1817 < BS <= 2127 |
| 36 | 2127 < BS <= 2490 |
| 37 | 2490 < BS <= 2915 |
| 38 | 2915 < BS <= 3413 |
| 39 | 3413 < BS <= 3995 |
| 40 | 3995 < BS <= 4677 |
| 41 | 4677 < BS <= 5476 |
| 42 | 5476 < BS <= 6411 |
| 43 | 6411 < BS <= 7505 |
| 44 | 7505 < BS <= 8787 |
| 45 | 8787 < BS <= 10287 |
| 46 | 10287 < BS <= 12043 |
| 47 | 12043 < BS <= 14099 |
| 48 | 14099 < BS <= 16507 |
| 49 | 16507 < BS <= 19325 |
| 50 | 19325 < BS <= 22624 |
| 51 | 22624 < BS <= 26487 |
| 52 | 26487 < BS <= 31009 |
| 53 | 31009 < BS <= 36304 |
| 54 | 36304 < BS <= 42502 |
| 55 | 42502 < BS <= 49759 |
| 56 | 49759 < BS <= 58255 |
| 57 | 58255 < BS <= 68201 |
| 58 | 68201 < BS <= 79846 |
| 59 | 79846 < BS <= 93479 |
| 60 | 93479 < BS <= 109439 |
| 61 | 109439 < BS <= 128125 |
| 62 | 128125 < BS <= 150000 |
| 63 | BS > 150000 |

TABLE 1-2
BSR Extended Buffer Size Level

| Index | BS value [bytes] |
|---|---|
| 0 | BS = 0 |
| 1 | 0 < BS <= 10 |
| 2 | 10 < BS <= 13 |
| 3 | 13 < BS <= 16 |
| 4 | 16 < BS <= 19 |
| 5 | 19 < BS <= 23 |
| 6 | 23 < BS <= 29 |
| 7 | 29 < BS <= 35 |
| 8 | 35 < BS <= 43 |
| 9 | 43 < BS <= 53 |
| 10 | 53 < BS <= 65 |
| 11 | 65 < BS <= 80 |
| 12 | 80 < BS <= 98 |
| 13 | 98 < BS <= 120 |
| 14 | 120 < BS <= 147 |
| 15 | 147 < BS <= 181 |
| 16 | 181 < BS <= 223 |
| 17 | 223 < BS <= 274 |
| 18 | 274 < BS <= 337 |
| 19 | 337 < BS <= 414 |
| 20 | 414 < BS <= 509 |
| 21 | 509 < BS <= 625 |
| 22 | 625 < BS <= 769 |
| 23 | 769 < BS <= 945 |
| 24 | 945 < BS <= 1162 |
| 25 | 1162 < BS <= 1429 |
| 26 | 1429 < BS <= 1757 |
| 27 | 1757 < BS <= 2161 |
| 28 | 2161 < BS <= 2657 |
| 29 | 2657 < BS <= 3267 |
| 30 | 3267 < BS <= 4017 |
| 31 | 4017 < BS <= 4940 |
| 32 | 4940 < BS <= 6074 |
| 33 | 6074 < BS <= 7469 |
| 34 | 7469 < BS <= 9185 |
| 35 | 9185 < BS <= 11294 |
| 36 | 11294 < BS <= 13888 |
| 37 | 13888 < BS <= 17077 |
| 38 | 17077 < BS <= 20999 |
| 39 | 20999 < BS <= 25822 |
| 40 | 25822 < BS <= 31752 |
| 41 | 31752 < BS <= 39045 |
| 42 | 39045 < BS <= 48012 |
| 43 | 48012 < BS <= 59039 |
| 44 | 59039 < BS <= 72598 |
| 45 | 72598 < BS <= 89272 |
| 46 | 89272 < BS <= 109774 |
| 47 | 109774 < BS <= 134986 |
| 48 | 134986 < BS <= 165989 |
| 49 | 165989 < BS <= 204111 |
| 50 | 204111 < BS <= 250990 |
| 51 | 250990 < BS <= 308634 |
| 52 | 308634 < BS <= 379519 |
| 53 | 379519 < BS <= 466683 |
| 54 | 466683 < BS <= 573866 |
| 55 | 573866 < BS <= 705666 |
| 56 | 705666 < BS <= 867737 |
| 57 | 867737 < BS <= 1067031 |
| 58 | 1067031 < BS <= 1312097 |
| 59 | 1312097 < BS <= 1613447 |
| 60 | 1613447 < BS <= 1984009 |
| 61 | 1984009 < BS <= 2439678 |
| 62 | 2439678 < BS <= 3000000 |
| 63 | BS > 3000000 |

Therefore, new behaviors need to be defined for the resources scheduled for the D2D transmission interrupted by the switching process, so as to reuse or utilize the physical resources occupied by the interrupted D2D transmission efficiently.

### SUMMARY

In order to achieve the above object, the present disclosure provides a mechanism for efficiently utilizing physical resources while switching between Mode 1 and Mode 2 in a D2D communication system. In particular, in order to efficiently utilize physical resources while a Mode 1 transmission is interrupted or while switching between Mode 1 and Mode 2 in a D2D communication system, all or part of resources scheduled for the interrupted transmission may be released.

In an aspect of the present disclosure, a method in a Device to Device (D2D) communication enabled terminal is provided. The method comprises: detecting a network condition during a D2D Mode 1 transmission and reporting the detected network condition to a base station to assist the base station in timely releasing physical resources scheduled for the terminal when the transmission is interrupted. The method further comprises: holding data scheduled to transmit in the interrupted transmission (or referred to as “interrupted schedule”) in response to the detected network condition satisfying a triggering condition of data reception interruption, and switching from Mode 1 to Mode 2 for transmitting the held data in Mode 2.

In some embodiments, the base station releases all of the physical resources scheduled for the interrupted transmission for the terminal when the network condition reported by the terminal satisfies the triggering condition of data reception interruption.

In some embodiments, the triggering condition of data reception interruption can be the network condition indicating that a radio link failure has occurred. In some other embodiments, the triggering condition of data reception interruption may be the network condition indicating that a radio link failure is about to occur or likely to occur, e.g., the network condition indicating a radio link quality lower than a predetermined standard.

In some embodiments, the terminal holds all the data scheduled to transmit in the interrupted schedule while switching from Mode 1 to Mode 2. Accordingly, after switching to Mode 2, the terminal will transmit all the data, including the data that has been transmitted in Mode 1.

In some embodiments, the terminal only holds data that is scheduled to transmit but has not been transmitted in the interrupted transmission while switching from Mode 1 to Mode 2, and discards data that has been transmitted in the current schedule. Accordingly, after switching to Mode 2, the terminal will only transmit the data that is scheduled to transmit but has not been transmitted.

In some embodiments, the terminal reports to the base station a radio link connection condition between the terminal and the base station as the network condition. Alternatively, in some other embodiments the terminal reports to the base station a channel measurement value at the terminal as the network condition.

In some embodiments, the terminal transmits the detected network condition to the base station periodically or aperiodically during the Mode 1 communication and when a BSR indicates that the data scheduled to transmit in the current schedule has not been transmitted completely. Alternatively and preferably, the terminal reports the detected network condition only when the current network condition is lower than a threshold, e.g., when the current channel measurement value is lower than a threshold.

In a second aspect of the present disclosure, a method in a Device to Device (D2D) communication enabled terminal is provided. The method comprises: detecting a network condition during a D2D Mode 1 transmission and reporting the detected network condition to a base station to assist the base station in timely releasing physical resources scheduled for the terminal when the transmission is interrupted; holding data that is scheduled to transmit but has not been transmitted in the interrupted transmission (or referred to as “interrupted schedule”) in response to the detected network condition satisfying a triggering condition of data reception interruption, and suspending Mode 1 until a successful cell reselection; and resuming the suspended Mode 1 to continue transmitting the held data that is scheduled to transmit but has not been transmitted in the interrupted transmission when a reselected cell is the same as an original cell accessed by the terminal before a radio link failure.

In some embodiments, physical resources allocated for the data that is scheduled to transmit but has not been transmitted in the interrupted transmission are reserved while Mode 1 is suspended, for use by the terminal for continuing transmitting or retransmitting the data scheduled to transmit in the current schedule after re-accessing the original cell and resuming Mode 1.

In some embodiments, no physical resource allocated for the data that is scheduled to transmit but has not been transmitted in the interrupted transmission is reserved while Mode 1 is suspended, and the method further comprises: requesting resources again while resuming Mode 1 so as to use the newly requested resources to continue transmitting the held data that is scheduled to transmit but has not been transmitted in the interrupted transmission.

In a third aspect of the present disclosure, a Device to Device (D2D) communication enabled terminal is provided. The method comprises: detecting a network condition during a D2D Mode 1 transmission and reporting the detected network condition to a base station to assist the base station in timely releasing physical resources scheduled for the terminal when the transmission is interrupted; and suspending the Mode 1 transmission in response to the detected network condition satisfying a triggering condition of data reception interruption or receiving from a network a command to switch to Mode 2, holding data that is scheduled to transmit but has not been transmitted in the interrupted transmission, and switching from Mode 1 to Mode 2 to transmit in Mode 2 the held data that is scheduled to transmit but has not been transmitted.

In some embodiments, the method may further comprise: suspending the Mode 2 transmission when a cell reselection occurs during the Mode 2 transmission and a reselected cell is the same as an original cell accessed by the terminal before a radio link failure, holding data that is scheduled to transmit but has not been transmitted in the interrupted Mode 2 transmission, and switching from Mode 2 to Mode 1 to continue transmitting in Mode 1 the held data that is scheduled to transmit but has not been transmitted in the interrupted Mode 2 transmission.

In some embodiments, the method may further comprise: returning to Mode 1 to transmit the held data that is scheduled to transmit but has not been transmitted when the terminal fails to switch from Mode 1 to Mode 2 within a predetermined period and reselects an original cell accessed by the terminal before a radio link failure. Generally, in the embodiments according to the third aspect of the present disclosure, the base station releases all of the physical resources scheduled for the interrupted transmission for the terminal when the network condition reported by the terminal satisfies the triggering condition of data reception interruption. Accordingly, when there is still data that has not been transmitted when the terminal returns to Mode 1, the terminal needs to request resources again for the data that has not been transmitted.

In a fourth aspect of the present disclosure, a Device to Device (D2D) communication enabled terminal is provided. The terminal comprises: a detecting unit configured to detect a network condition during a D2D Mode 1 transmission; a reporting unit configured to report the detected network condition to a base station to assist the base station in timely releasing physical resources scheduled for the terminal when the transmission is interrupted; a mode switching unit configured to hold data scheduled to transmit in the interrupted transmission in response to the detected network condition satisfying a triggering condition of data reception interruption, and switch from Mode 1 to Mode 2; and a data transmitting unit configured to transmit the held data in Mode 2.

In a fifth aspect of the present disclosure, a Device to Device (D2D) communication enabled terminal is provided. The terminal comprises a detecting unit configured to detect a network condition during a D2D Mode 1 transmission; a reporting unit configured to report the detected network condition to a base station to assist the base station in timely releasing physical resources scheduled for the terminal when the transmission is interrupted; a suspending unit configured to hold data that is scheduled to transmit but has not been transmitted in the interrupted transmission in response to the detected network condition satisfying a triggering condition of data reception interruption, and suspend Mode 1 until a successful cell reselection; and a resuming unit configured to resume the suspended Mode 1 to continue transmitting the held data that is scheduled to transmit but has not been transmitted in the interrupted transmission when a reselected cell is the same as an original cell accessed by the terminal before a radio link failure.

In some embodiments, the suspending unit is further configured to reserve physical resources allocated for the data that is scheduled to transmit but has not been transmitted in the interrupted transmission while Mode 1 is suspended, for use by the terminal for continuing transmitting or retransmitting the data scheduled to transmit in the current schedule after re-accessing the original cell and resuming Mode 1.

In some embodiments, the suspending unit is further configured to not reserve physical resource allocated for the data that is scheduled to transmit but has not been transmitted in the interrupted transmission while Mode 1 is suspended, and the terminal further comprises a resource requesting unit configured to request resources again while resuming Mode 1 so as to use the newly requested resources to continue transmitting the held data that is scheduled to transmit but has not been transmitted in the interrupted transmission.

In a sixth aspect of the present disclosure, a Device to Device (D2D) communication enabled terminal is provided. The terminal comprises: a detecting unit configured to detect a network condition during a D2D Mode 1 transmission; a reporting unit configured report the detected network condition to a base station to assist the base station in timely releasing physical resources scheduled for the terminal when the transmission is interrupted; a receiving unit configured to receive a command from a network; and a mode switching unit configured to suspend the Mode 1 transmission in response to the detected network condition satisfying a triggering condition of data reception interruption or receiving from a network a command to switch to Mode 2, hold data that is scheduled to transmit but has not been transmitted in the interrupted transmission, and switch from Mode 1 to Mode 2 to transmit in Mode 2 the held data that is scheduled to transmit but has not been transmitted.

In some embodiments, the terminal further comprises: a resuming unit configured to suspend the Mode 2 transmission when a cell reselection occurs during the Mode 2 transmission and a reselected cell is the same as an original cell accessed by the terminal before a radio link failure, hold data that is scheduled to transmit but has not been transmitted in the interrupted Mode 2 transmission, and switch from Mode 2 to Mode 1 to continue transmitting in Mode 1 the held data that is scheduled to transmit but has not been transmitted in the interrupted Mode 2 transmission.

In some embodiments, the resuming unit is further configured to return to Mode 1 to transmit the held data that is scheduled to transmit but has not been transmitted when the terminal fails to switch from Mode 1 to Mode 2 within a predetermined period and reselects an original cell accessed by the terminal before a radio link failure.

With the methods according to the present disclosure, when a D2D communication terminal leaves a Mode 1 transmission, all or part of resources scheduled for the interrupted transmission can be released timely for reuse again. In this way, with the methods according to the present disclosure, the resource utilization in the D2D communication system can be improved and a better network performance gain can be achieved.

### BRIEF DESCRIPTION OF THE DRAWINGS

The above and other objects, features and advantages will be more apparent from the following description of embodiments with reference to the figures, in which:

FIG. 1 is a flowchart of a method according a first embodiment of the present disclosure;

FIG. 2 is a flowchart of an implementation of the method according the first embodiment of the present disclosure;

FIG. 3 is a flowchart of another implementation of the method according the first embodiment of the present disclosure;

FIG. 4 shows a block diagram of a D2D terminal according to a first embodiment of the present disclosure;

FIG. 5 is a flowchart of a method according a second embodiment of the present disclosure;

FIG. 6 is a flowchart of an implementation of the method according the second embodiment of the present disclosure;

FIG. 7 is a flowchart of another implementation of the method according the second embodiment of the present disclosure;

FIG. 8 is a block diagram of a D2D terminal according a second embodiment of the present disclosure;

FIG. 9 is a flowchart of a method according a third embodiment of the present disclosure;

FIG. 10 is a flowchart of an implementation of the method according the third embodiment of the present disclosure;

FIG. 11 is a block diagram of a D2D terminal according a third embodiment of the present disclosure;

FIG. 12-1-a shows a first timing relationship between an attempt to switch to Mode 2 and an attempt to switch back to Mode 1 and a timing sequence of the entire switching process according to the third embodiment of the present disclosure;

FIG. 12-1-b shows a second timing relationship between an attempt to switch to Mode 2 and an attempt to switch back to Mode 1 and a timing sequence of the entire switching process according to the third embodiment of the present disclosure;

FIG. 12-1-c shows a third timing relationship between an attempt to switch to Mode 2 and an attempt to switch back to Mode 1 and a timing sequence of the entire switching process according to the third embodiment of the present disclosure;

FIG. 12-1-d shows a fourth timing relationship between an attempt to switch to Mode 2 and an attempt to switch back to Mode 1 and a timing sequence of the entire switching process according to the third embodiment of the present disclosure;

FIG. 12-2-a shows a first timing relationship between an attempt to switch to Mode 2 and an attempt to switch back to Mode 1 and a timing sequence of the entire switching process when the mode switching is triggered in a more radical condition (i.e., triggered at the start of T310) according to the third embodiment of the present disclosure;

FIG. 12-2-b shows a second timing relationship between an attempt to switch to Mode 2 and an attempt to switch back to Mode 1 and a timing sequence of the entire switching process when the mode switching is triggered in a more radical condition (i.e., triggered at the start of T310) according to the third embodiment of the present disclosure;

FIG. 12-2-c shows a third timing relationship between an attempt to switch to Mode 2 and an attempt to switch back to Mode 1 and a timing sequence of the entire switching process when the mode switching is triggered in a more radical condition (i.e., triggered at the start of T310) according to the third embodiment of the present disclosure; and

FIG. 12-2-d shows a fourth timing relationship between an attempt to switch to Mode 2 and an attempt to switch back to Mode 1 and a timing sequence of the entire switching process when the mode switching is triggered in a more radical condition (i.e., triggered at the start of T310) according to the third embodiment of the present disclosure.

Throughout the figures of the present disclosure, the same or similar elements are represented by the same or similar reference signs.

### DETAILED DESCRIPTION

In the following, the present disclosure will be described in detail with reference to figures which show the illustrative embodiments of the present disclosure to enable those skilled in the art to carry out the present disclosure. It should be noted that the following figures and examples are not intended to limit the scope of the present disclosure to those embodiments. Rather, it is possible to form other embodiments by exchanging and combining some or all elements described or shown in different embodiments. Further, in case where some particular embodiments of the present disclosure can be partly or fully implemented using known components, among the known components, only those required for understanding the present disclosure will be described and details of the rest of the known components will be omitted so as not to obscure the present disclosure. Unless indicated otherwise, it should be appreciated by those skilled in the art that, while some of the embodiments of the present disclosure are described as software implementations, the present disclosure is not limited to this and hardware implementations or combination of software and hardware implementations are also possible, and vice versa. Unless indicated otherwise, in the present disclosure, any embodiment showing a single component should be construed as limiting, and the present disclosure is intended to encompass other embodiments including a plurality of the same components, and vice versa. Further, the present disclosure encompasses equivalents of known components referenced herein as examples, either currently available or developed in the future.

As described above, the object of the present disclosure is to provide mechanisms for efficiently utilizing physical resources while switching between Mode 1 and Mode 2 in a D2D communication system. The present disclosure provides several mechanisms for reserving and releasing all or part of resources scheduled for the transmission interrupted when switching between Mode 1 and Mode 2, and introduces respective behaviors at a terminal (also referred to as UE) and a base station. To facilitate understanding, the present disclosure will be described with reference to 3GPP TS 36.321 and 3GPP TS 36.331, but the present disclosure is not limited thereto.

In particular, the present disclosure provides two types of physical layer processes for efficiently utilizing resources while switching between Mode 1 and Mode 1 during a D2D communication: Physical Layer Process 1 and Physical Layer Process 2, which will be described below.

In the Physical Layer Process 1, a D2D terminal (e.g., a UE) reports its network condition via some mechanism before a Radio Link Failure (RLF) occurs. A base station (e.g., eNB) determines the D2D transmission mode the UE should be operate in, as well as a series of signaling involved in its entire physical layer procedure, based on the network condition reported from the UE. The Physical Layer Process 1 may have two alternative implementations: Physical Layer Process 1-1 and Physical Layer Process 1-2. In the Physical Layer Process 1-1, the D2D terminal reports to the eNB a current radio link connection condition between the D2D terminal and the eNB, i.e., whether the network is in a normal connection state. The eNB will decide whether to continue scheduling or release the resources based on the condition reported from the D2D terminal. In the Physical Layer Process 1-2, the D2D terminal reports to the eNB a current signal quality received by the D2D terminal from the cellular network, i.e., a signal measurement value (e.g., RSRP or RSRQ). The eNB will determine, based on the signal quality reported from the D2D terminal, the D2D transmission mode the terminal should be operated in, and decide whether to continue scheduling or release the resources. A triggering condition for the Physical Layer Process 1 may be the D2D transmitting terminal being scheduled by the network and the BSR data to be transmitted in the current schedule requested by the UE having not been transmitted completely. For example, when the UE is in the normal Mode 1 transmission and the data scheduled to transmit in the current schedule has not been completed, it may transmit the detected network condition to the base station periodically or aperiodically. Another triggering condition for the Physical Layer Process 1 is the above triggering condition being met and the current channel measurement value (e.g., RSRP or RSRQ) being lower than a preconfigured threshold.

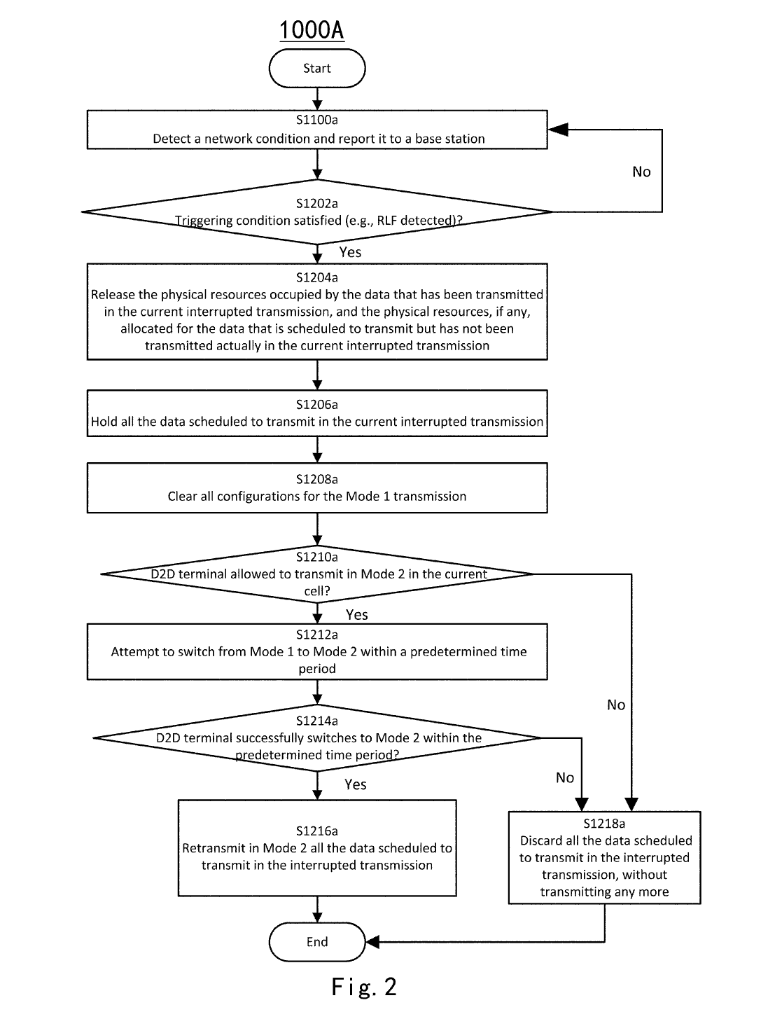

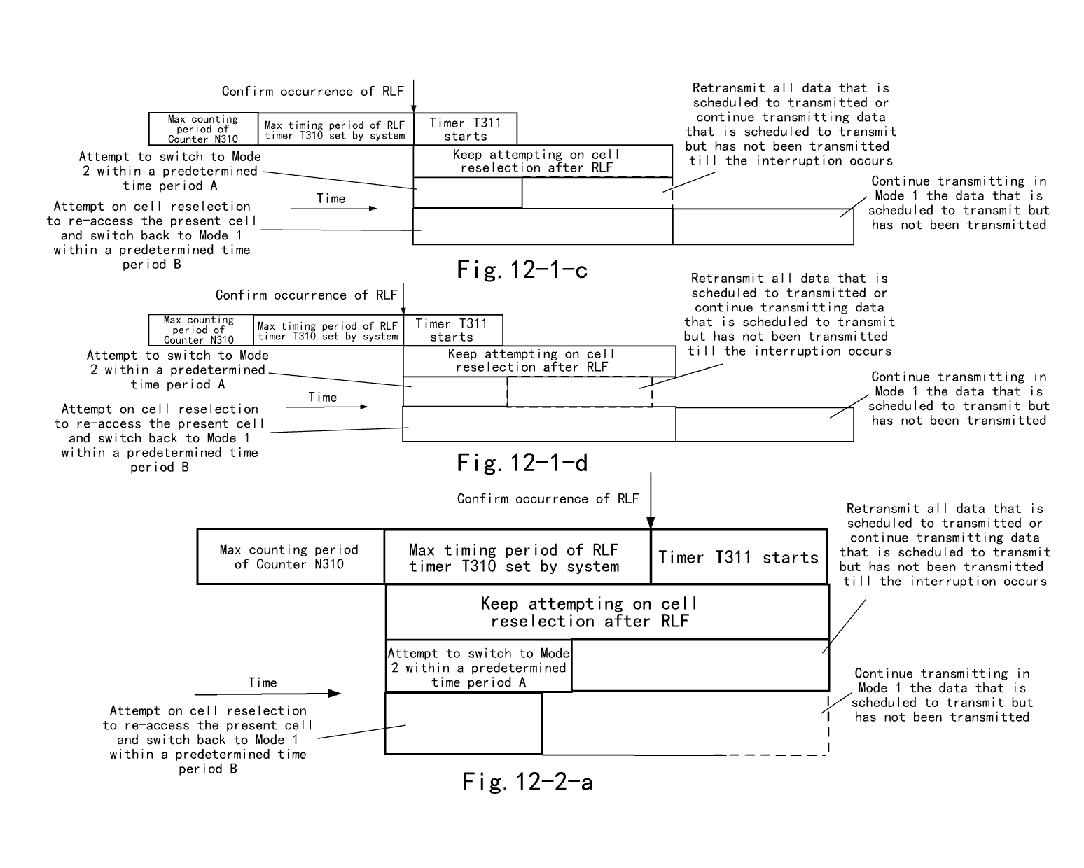

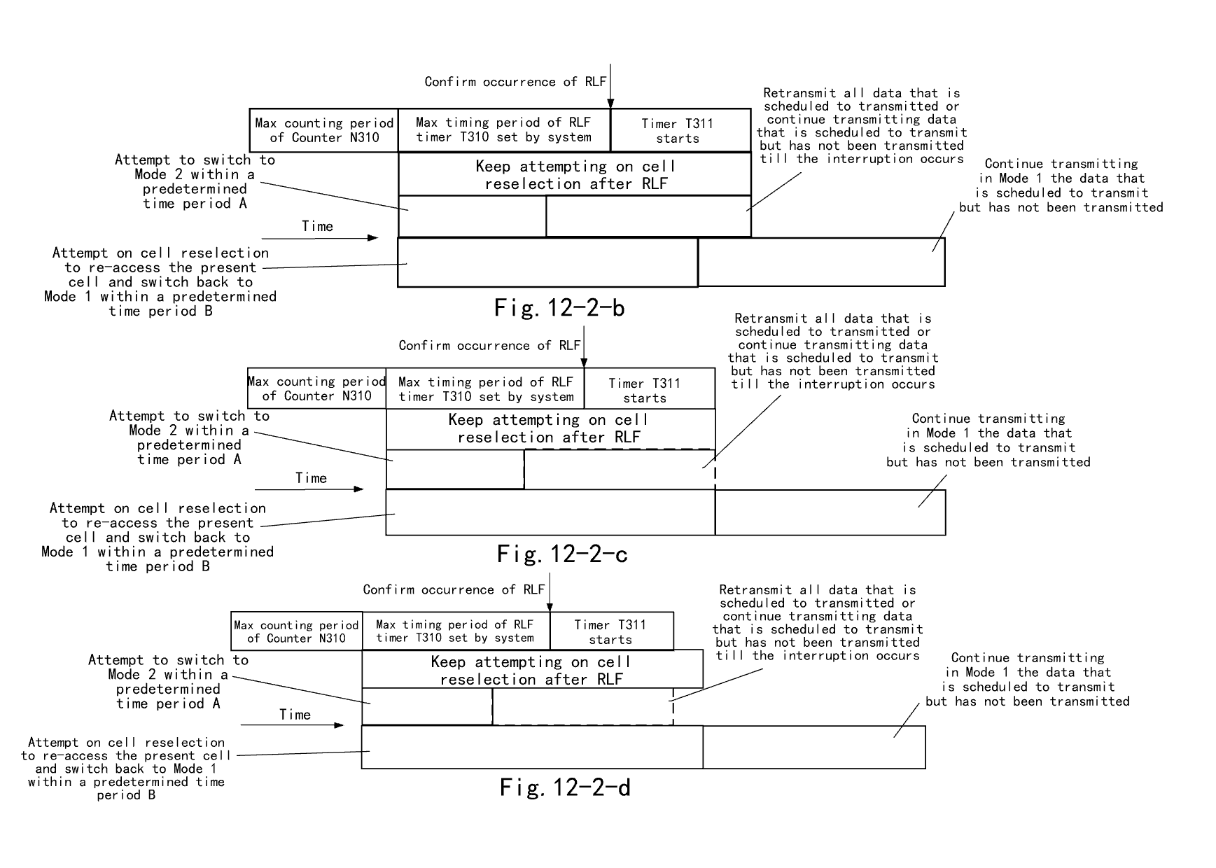

In the Physical Layer Process 2, the D2D terminal (e.g., UE) will decide, based on the current network condition and a corresponding configuration at the base station (e.g., eNB), whether its D2D transmission mode should be switched or not and whether to continue scheduling or release the resources during this process. The Physical Layer Process 2 specifies several UE behaviors of the D2D terminal during D2D mode switching. A triggering condition of the Physical Layer Process 2 may be the current network condition indicating that an RLF has occurred. For example, the Physical Layer Process 2 may be triggered after the cell reselection timer T301 or T311 is started. Alternatively, a more radical triggering condition of the Physical Layer Process 2 may be the current network condition indicating that an RLF is about to occur. For example, the Physical Layer Process 2 may be triggered when the cell handover process counter N310 reaches its maximum value and the timer T310 is started (as shown in FIG. 12-2-a, FIG. 12-2-b, FIG. 12-2-c or FIG. 12-2-d). The definitions of T301, T311, T310 and N310 are the same as those given in 3GPP TS 36.321, as shown in Table 2-1 and Table 2-2 below, which correspond to Table 7.3 and Table 7.4 in 3GPP TS 36.331, respectively.

TABLE 2-1

| Timer | Start | Stop | At expiry |
|---|---|---|---|
| T301 | Transmission of | Reception of | Go to RRC_IDLE |
| | RRCConnectionReestabilshmentRequest | RRCConnectionReestablishment | |
| | | or | |
| | | RRCConnectionReestablishmentReject | |
| | | message as well as | |
| | | when the selected cell | |
| | | becomes unsuitable | |
| T310 | Upon detecting | Upon receiving N311 | If security is not |
| | physical layer | consecutive in-sync | activated: go to |
| | problems for the | indications from lower | RRC_IDLE else: initiate |
| | PCell i.e. upon | layers for the PCell, | the connection |
| | receiving N310 | upon triggering the | re-establishment |
| | consecutive | handover procedure and | procedure |
| | out-of-sync | upon initiating the | |
| | indications from | connection | |
| | lower layers | re-establishment | |
| | | procedure | |
| T311 | Upon initiating the | Selection of a suitable | Enter RRC_IDLE |
| | RRC connection | E-UTRA cell or a cell | |
| | re-establishment | using another RAT. | |
| | procedure | | |

TABLE 2-2

| Constant | Usage |
|---|---|
| N310 | Maximum number of consecutive “out-of-sync” indications |
| | for the PCell received from lower layers |
| N311 | Maximum number of consecutive “in-sync” indications |
| | for the PCell received from lower layers |

The Physical Layer Process 2 may be classified into two types. In the first type of Physical Layer Process 2, when the triggering condition is met (e.g., after an RLF has been detected and confirmed), the terminal releases the physical resources allocated for the current schedule immediately, without waiting to attempt to switch back to the current cell mode, Mode 1. The first type of Physical Layer Process 2 may be performed based on the implementations 2-1, 2-2 and 2-5 as described below. In the second type of Physical Layer Process 2, when the triggering condition is met (e.g., after an RLF has been detected and confirmed), the terminal waits to attempt to switch back to the current cell mode, Mode 1, for a predetermined period. During the waiting period, not all of the physical resources allocated for the current schedule will be released and the relevant resources will be reserved for use by the D2D terminal to continue transmitting the related data in the current schedule after switching back to the current cell mode, Mode 1. For example, during the waiting period, the physical resources occupied by the data that has been transmitted in the interrupted schedule may be released, while the physical resources allocated for the data that is scheduled to transmit but has not been transmitted in the interrupted schedule will be reserved. The second type of Physical Layer Process 2 may be performed based on the implementations 2-3 and 2-4 as described below.

There may be a number of implementations for the Physical Layer Process 2. In the following, five implementations will be introduced, referred to as Physical Layer Process 2-1, Physical Layer Process 2-2, Physical Layer Process 2-3, Physical Layer Process 2-4 and Physical Layer Process 2-5, respectively.

In the Physical Layer Process 2-1, the D2D terminal releases all physical resources allocated for the interrupted schedule while switching from Mode 1 to Mode 2 (i.e., the physical resources occupied by the data that has been transmitted in the current interrupted schedule and the physical resources allocated for the data that is scheduled to transmit but has not been transmitted actually in the current interrupted schedule), holds all data scheduled in the current schedule, clears all configurations for the Mode 1 transmission, and switches to Mode 2 to retransmit all the data scheduled in the current interrupted schedule.

In the Physical Layer Process 2-2, the D2D terminal releases all physical resources allocated for the interrupted schedule while switching from Mode 1 to Mode 2, holds the data that is scheduled to transmit but has not been transmitted in the current schedule, clears all configurations for the Mode 1 transmission, and switches to Mode 2 to transmit the data that is scheduled to transmit but has not been transmitted in the current schedule.

In the Physical Layer Process 2-3, the D2D terminal suspends the Mode 1 transmission, reserves the relevant resources allocated for the current schedule, waits for the cell reselection result of switching back to the current cell, and then continues transmitting the data that is scheduled to transmit but has not been transmitted in the current interrupted schedule over the reserved relevant resources. In the Physical Layer Process 2-3, the D2D terminal releases the physical resources occupied by the data that has been transmitted in the current interrupted schedule and reserves the physical resources allocated for the data that is scheduled to transmit but has not been transmitted actually, for use to continue transmitting the data that is scheduled to transmit but has not been transmitted after switching back to the current cell mode, Mode 1. The relevant configurations of Mode 1 are reserved. The data that has been transmitted in the current schedule is discarded, while the remaining data that is scheduled to transmit but has not been transmitted in the current interrupted schedule is held for a time period in which the terminal waits for the cell reselection result: whether it will be reconnected to the current cell. If the D2D terminal is reconnected to the current cell within the time period, it will switch back to Mode 1 and continue transmitting the held data that is scheduled to transmit but has not been transmitted in the current interrupted schedule in Mode 1 over the physical resources allocated for data that is scheduled to transmit but has not been transmitted actually. If the D2D terminal is not reconnected to the current cell and return to Mode 1 within the time period, it will discard the data and the corresponding Mode 1 transmission configuration, without transmitting the data that is scheduled to transmit but has not been transmitted in the current interrupted schedule.

The Physical Layer Process 2-4 is similar to the Physical Layer Process 2-3, with the difference in that, when the Mode 1 transmission is suspended, the D2D terminal does not reserve the relevant resources allocated for the current schedule, but instead requests resource again for the data that is scheduled to transmit but has not been transmitted in the current interrupted schedule after the the cell reselection result is to switch back to the current cell. In the Physical Layer Process 2-4, the D2D terminal releases the physical resources occupied by the data that has been transmitted in the interrupted schedule and the physical resources, if any, allocated for the data that is scheduled to transmit but has not been transmitted actually, and holds all the data scheduled to transmit in the interrupted schedule (or the data that is scheduled to transmit but has not been transmitted) for a time period, in which the terminal waits whether it will be reconnected to the current cell or not. If the D2D terminal is reconnected to the current cell within the time period, it will request a new schedule grant from the eNB of the current cell again and retransmit all the data (or the data that is scheduled to transmit but has not been transmitted) of the previously interrupted schedule in accordance with the requested new schedule grant. If the D2D terminal is not reconnected to the current cell and return to Mode 1 within the time period, it will discard the data and the corresponding Mode 1 transmission configuration, without transmitting the data that has been interrupted.

Similarly to the Physical Layer Process 2-4, in the Physical Layer Process 2-5, the D2D terminal releases the physical resources occupied by the data that has been transmitted in the interrupted schedule and the physical resources, if any, allocated for the data that is scheduled to transmit but has not been transmitted actually, and holds the data that is scheduled to transmit but has not been transmitted in the interrupted schedule for a time period, in which the terminal waits whether it will be reconnected to the current cell or not. The Physical Layer Process 2-5 differs from the Physical Layer Process 2-4 in that, while waiting for the cell reselection result, the D2D terminal attempts to switch to Mode 2. If the D2D terminal successfully switches to Mode 2, it may continue transmitting in Mode 2 the data that is scheduled to transmit but has not been transmitted in the interrupted schedule while waiting for the cell reselection result. If the cell reselection occurs in a particular schedule during the Mode 2 transmission, the Mode 2 transmission will be stopped, the resources allocated for the Mode 2 transmission (including the resources occupied by the data that has been transmitted and the resources allocated for the data that is scheduled to transmit but has not been transmitted) will be released, the data that has been transmitted by far in the interrupted schedule will be discarded, and the data that is scheduled to transmit but has not been transmitted in the interrupted schedule will be held. If the cell reselection result within the waiting period is to switch back to the current cell, the data that is scheduled to transmit but has not been transmitted in the current interrupted schedule will be transmitted in Mode 1. If the terminal does not switch back to the current cell within the waiting period, all of the data of the current interrupted schedule will be discarded, without being transmitted any more. If the D2D terminal fails to switch to Mode 2 for transmission after the current schedule has been interrupted and before re-accessing the same cell as the one it accessed before by means of cell reselection, it will hold the data that is scheduled to transmit but has not been transmitted in the current schedule, discard the data that has been transmitted previously and wait whether the cell reselection result is to switch back to the current cell or not. If the terminal successfully switches back to Mode 1 within a predetermined period, the data that is scheduled to transmit but has not been transmitted in the interrupted schedule will be continue to transmit in Mode 1 (in this case it needs to request a new schedule grant). If the terminal does not switch back to the current cell within the waiting period, all of the data of the current interrupted schedule will be discarded, without being transmitted any more.

The above physical layer processes may vary depending on different RRC configurations.

The above physical layer processes will be described in detail below with reference to the figures and embodiments. The following description will be given generally from the perspective of the D2D terminal, but does not exclude description of behaviors at the base station.

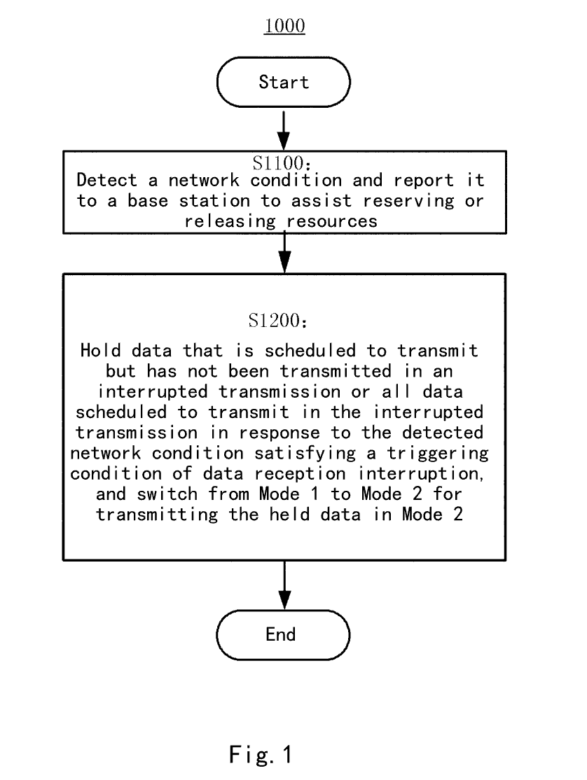

FIG. 1 is a flowchart of a method 1000 according a first embodiment of the present disclosure.

As described above, a D2D communication mode with network scheduling and control, i.e., Mode 1, is typically adopted by a D2D terminal within network coverage. The method 1000 starts with a D2D terminal in a Mode 1 transmission.

At step S1100, the D2D terminal detects a network condition and reports the detected network condition to a base station to assist the base station in timely releasing physical resources scheduled for the terminal when the transmission is interrupted.

In the step S1100, the above Physical Layer Process 1 will be implemented, which may include any of the following two implementations.

Implementation of Physical Layer Process 1-1

The D2D terminal reports to the eNB a current radio link connection condition between the D2D terminal and the eNB, i.e., whether the network is in a normal connection state. The eNB will decide to continue scheduling or release the resources based on the condition reported from the D2D terminal. The physical layer process will be triggered when the following conditions are partly met:

1. The D2D transmitting terminal is being scheduled by the network;

2. The BSR data requested by the UE to be transmitted in the current schedule has not been transmitted completely; and

3. The current channel measurement value (e.g., RSRP or RSRQ) is lower than a preconfigured threshold.

The Physical Layer Process 1-1 may be triggered when the conditions 1 and 2 are both met, e.g., periodically during the Mode 1 transmission. Alternatively, the Physical Layer Process 1-1 may be triggered when all the conditions 1, 2 and 3 are met.

In the Physical Layer Process 1-1, the D2D transmitting terminal reports the current network connection condition to the network in the above triggering conditions, i.e., whether the D2D transmitting terminal is currently in a normal connection state with the network. The reported information may be carried in RRC signaling (e.g., directly carried in the content of SR or BSR), in a MAC CE, or in uplink control information (UE).

Implementation of Physical Layer Process 1-2

In the Physical Layer Process 1-2, the D2D terminal reports to the eNB a current signal measurement value (e.g., RSRP or RSRQ) of the cellular network at the D2D terminal. The eNB will decide to continue scheduling or release the resources based on the report from the D2D terminal. The Physical Layer Process 1-2 will be triggered when the following conditions are partly met:

1. The D2D transmitting terminal is being scheduled by the network;

2. The BSR data requested by the UE to be transmitted in the current schedule has not been transmitted completely; and

3. The current channel measurement value (e.g., RSRP or RSRQ) is lower than a preconfigured threshold.

Similarly to the Physical Layer Process 1-1, the Physical Layer Process 1-2 may be triggered when the conditions 1 and 2 are both met. Alternatively, the Physical Layer Process 1-1 may be triggered when all the conditions 1, 2 and 3 are met. In the latter case, when the downlink channel measurement value is lower than the preconfigured threshold, the D2D transmitting terminal will be triggered to report to the network the information related to D2D transmission mode selection. On the other hand, when the downlink channel measurement value is higher than the preconfigured threshold, the D2D transmitting terminal will not be triggered to report to the network the information related to D2D transmission mode selection.

In the Physical Layer Process 1-2, the D2D transmitting terminal reports the current measurement value of the cellular network, i.e., the current channel measurement value, to the network in the above triggering conditions. The reported information may be carried in RRC signaling, in a MAC CE, or in uplink control information (UE).

At step S1200, the D2D terminal holds data scheduled to transmit in the interrupted transmission in response to the detected network condition satisfying a triggering condition of data reception interruption, and switches from Mode 1 to Mode 2 for transmitting the held data in Mode 2. In some embodiments, when the detected network condition satisfies the triggering condition of data reception interruption, the D2D terminal holds all the data scheduled to transmit in the interrupted transmission. Accordingly, after successfully switching to Mode 2, the terminal will retransmit in Mode 2 all the data scheduled to transmit in the interrupted transmission. In some other embodiments, when the detected network condition satisfies the triggering condition of data reception interruption, the D2D terminal holds the data that is scheduled to transmit but has not been transmitted in the interrupted transmission, but not the data that has been transmitted. Accordingly, after successfully switching to Mode 2, the terminal will continue transmitting in Mode 2 the data that is scheduled to transmit but has not been transmitted in the current schedule. The Physical Layer Process 2 may be implemented in the step S1200.

The triggering condition of data reception interruption, i.e., the triggering condition of the Physical Layer Process 2, may be the current network condition indicating that an RLF has occurred. For example, the Physical Layer Process 2 may be triggered after the cell reselection timer T301 or T311 is started. Alternatively, a more radical triggering condition of the Physical Layer Process 2 may be the current network condition indicating that an RLF is about to occur. For example, the Physical Layer Process 2 may be triggered when the cell handover process counter N310 reaches its maximum value and after the timer T310 is started (as shown in FIG. 12-2-a, FIG. 12-2-b, FIG. 12-2-c or FIG. 12-2-d).

The step S1200 may be implemented by the Physical Layer Process 2-1 or the Physical Layer Process 2-2, which will be described in detail below. Then, the method 1000 ends.

FIG. 2 is a flowchart of an implementation 1000A of the method 1000 according the first embodiment of the present disclosure.

Likewise, the method 1000A starts with a D2D terminal in a Mode 1 transmission. The step S1100a is the same as the step S1100, and the description thereof will be omitted here.

The subsequent parts of the method 1000A describe details of the steps in the Physical Layer Process 2-1.

At step S1202a, the D2D terminal determines whether the detected network condition satisfies a triggering condition of data reception interruption, e.g., whether an RLF has occurred. If the triggering condition is satisfied, the method proceeds with step S1204a; otherwise it returns to step S1100a.

At step S1204a, the physical resources occupied by the data that has been transmitted in the current interrupted schedule, and the physical resources, if any, allocated for the data that is scheduled to transmit but has not been transmitted actually, are released.

At step S1206a, all the data scheduled to transmit in the current interrupted schedule, including the data that has been transmitted, is held.

At step S1208a, all configurations for the Mode 1 transmission are cleared.

At step S1210a, it is determined whether the network configuration allows the terminal to transmit in Mode 2. If so, the method proceeds with step S1212a; otherwise the method proceeds with step S1218a where all the data of the current interrupted schedule is discarded, without being transmitted any more.

At step S1212a, an attempt to switch from Mode 1 to Mode 2 is made within a predetermined time period.

At step S1214a, it is determined whether the D2D terminal has successfully switched to Mode 2 within the predetermined time period. If so, the method proceeds with step S1216a; otherwise the method proceeds with step S1218a where all the data of the current interrupted schedule is discarded, without being transmitted any more.

At step S1216a, the terminal retransmits all the data scheduled in the current schedule, including the data that has been transmitted before the current schedule was interrupted and the data that is scheduled to transmit but has not been transmitted, in the transmission mode of Mode 2. It is to be noted here that the resources used by the terminal in Mode 2 are obtained by means of contention, rather than being scheduled by the base station.

Then, the method 1000A ends.

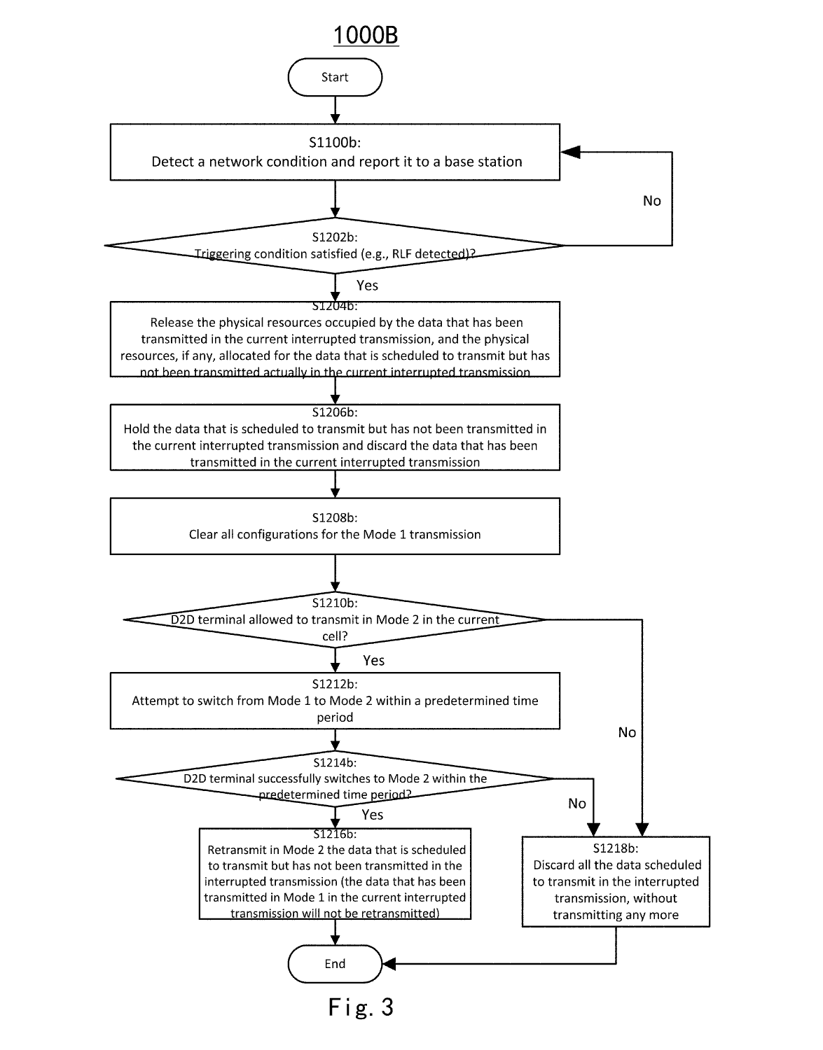

FIG. 3 is a flowchart of another implementation 1000B of the method 1000 according the first embodiment of the present disclosure.

Likewise, the method 1000B starts with a D2D terminal in a Mode 1 transmission. The step S1100b is the same as the step S1100, and the description thereof will be omitted here.

The subsequent parts of the method 1000B describe details of the steps in the Physical Layer Process 2-2.

At step S1202b, the D2D terminal determines whether the detected network condition satisfies a triggering condition of data reception interruption, e.g., whether an RLF has occurred. If the triggering condition is satisfied, the method proceeds with step S1204b; otherwise it returns to step S1100b.

At step S1204b, the physical resources occupied by the data that has been transmitted in the current interrupted schedule, and the physical resources, if any, allocated for the data that is scheduled to transmit but has not been transmitted actually, are released.

At step S1206b, the data that is scheduled to transmit but has not been transmitted in the interrupted schedule is held, while the data that has been transmitted in the current schedule is discarded.

At step S1208b, all configurations for the Mode 1 transmission are cleared.

At step S1210b, it is determined whether the network configuration allows the terminal to transmit in Mode 2. If so, the method proceeds with step S1212b; otherwise the method proceeds with step S1218b where all the data of the current interrupted schedule is discarded, without being transmitted any more.

At step S1212b, an attempt to switch from Mode 1 to Mode 2 is made within a predetermined time period.

At step S1214b, it is determined whether the D2D terminal has successfully switched to Mode 2 within the predetermined time period. If so, the method proceeds with step S1216b; otherwise the method proceeds with step S1218b where all the data of the current interrupted schedule is discarded, without being transmitted any more.

At step S1216b, the terminal continues transmitting the data that is scheduled to transmit but has not been transmitted in the interrupted schedule in the transmission mode of Mode 2 (the data that has been transmitted in Mode 1 before the current schedule was interrupted will not be retransmitted).

Then, the method 1000B ends.

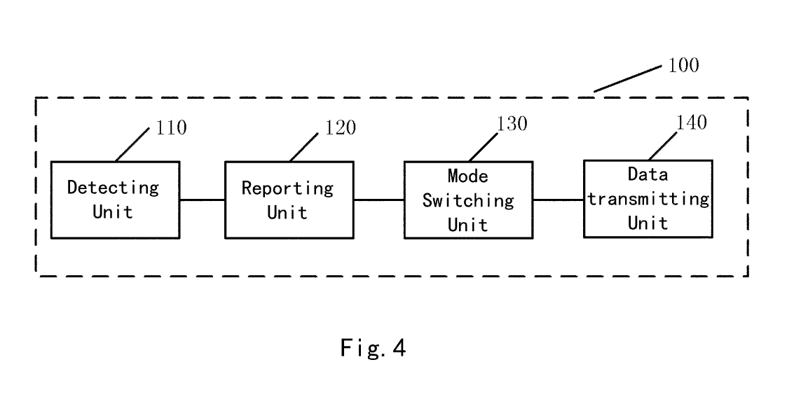

FIG. 4 shows an exemplary D2D terminal 100 according to a first embodiment of the present disclosure. As shown, the terminal 100 may include a detecting unit 110, a reporting unit 120, a mode switching unit 130 and a data transmitting unit 140.

The detecting unit 110 may detect a network condition during a D2D Mode 1 transmission.

The reporting unit 120 may report the detected network condition to a base station to assist the base station in timely releasing physical resources scheduled for the terminal when the transmission is interrupted.

The mode switching unit 130 may hold data scheduled to transmit in the interrupted transmission in response to the detected network condition satisfying a triggering condition of data reception interruption, and switch from Mode 1 to Mode 2 for transmitting the held data. The held data may be all the data scheduled to transmit in the interrupted transmission. Alternatively, the held data may include only the data that is scheduled to transmit but has not been transmitted in the interrupted transmission, but not the data that has been transmitted in the interrupted transmission.

After the mode switching unit 130 has completed its operation, i.e., has successfully switched from Mode 1 to Mode 2 in a predetermined period, the data transmitting unit 140 may transmit the held data in Mode 2, e.g., continuing transmitting in Mode 2 the data that is scheduled to transmit but has not been transmitted in the interrupted transmission or retransmitting in Mode 2 all the data scheduled to transmit in the interrupted transmission.

The D2D terminal 100 may implement the above method 1000 or its implementations 1000A and 1000B with cooperation of the respective components. The detection unit 110 and the reporting unit 120 may be configured to implement the above steps S1100, S1100a or S1100b. The mode switching unit 130 and the data transmitting unit 140 may be configured to implement the step S1200 in the method 1000, or the operations of the Physical Layer Process 2-1, or the operations of the Physical Layer Process 2-2. Description of the details will be omitted here.

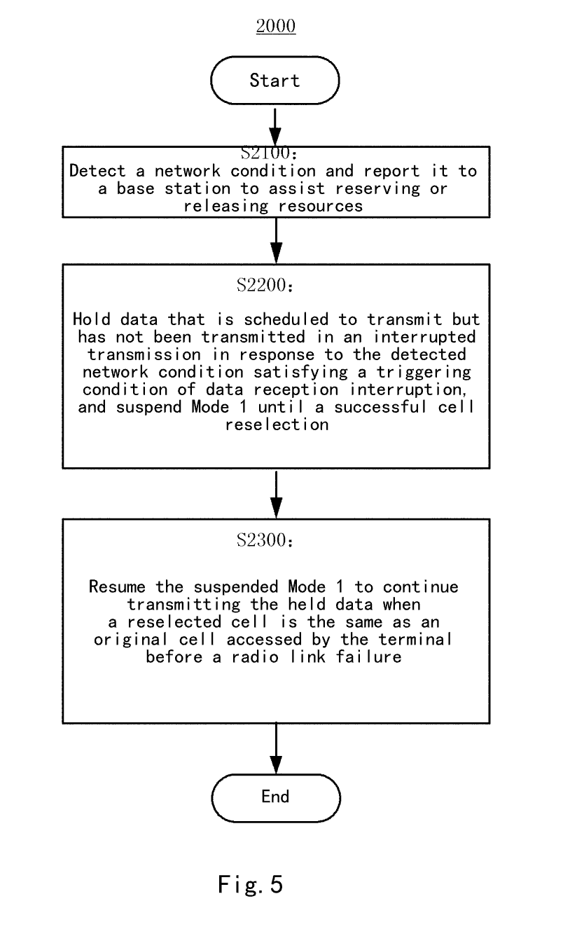

FIG. 5 is a flowchart of a method 2000 according a second embodiment of the present disclosure.

As described above, a D2D communication mode with network scheduling and control, i.e., Mode 1, is typically adopted by a D2D terminal within network coverage. The method 2000 starts with a D2D terminal in a Mode 1 transmission.

At step S2100, the D2D terminal detects a network condition and reports the detected network condition to a base station to assist the base station in timely releasing physical resources scheduled for the terminal when the transmission is interrupted. The step S2100 is similar to the steps S1100 in the method 1000 and details thereof will be omitted here.

At step S2200, the D2D terminal holds data that is scheduled to transmit but has not been transmitted in the interrupted transmission in response to the detected network condition satisfying a triggering condition of data reception interruption, and suspends Mode 1 until a successful cell reselection.

At step S2300, the D2D terminal resumes the suspended Mode 1 to continue transmitting the held data that is scheduled to transmit but has not been transmitted in the interrupted transmission when a reselected cell is the same as an original cell accessed by the terminal before a radio link failure.

The steps S2200 and S2300 implement the Physical Layer Process 2.

Similarly to the method 1000, the triggering condition of data reception interruption, i.e., the triggering condition of the Physical Layer Process 2, in the step S2200 may be the current network condition indicating that an RLF has occurred. For example, the Physical Layer Process 2 may be triggered after the cell reselection timer T301 or T311 is started. Alternatively, a more radical triggering condition of the Physical Layer Process 2 may be the current network condition indicating that an RLF is about to occur. For example, the Physical Layer Process 2 may be triggered when the cell handover process counter N310 reaches its maximum value and after the timer T310 is started.

The steps S2200 and S2300 may be implemented by the Physical Layer Process 2-3 or the Physical Layer Process 2-4, which will be described in detail below. Then, the method 2000 ends.

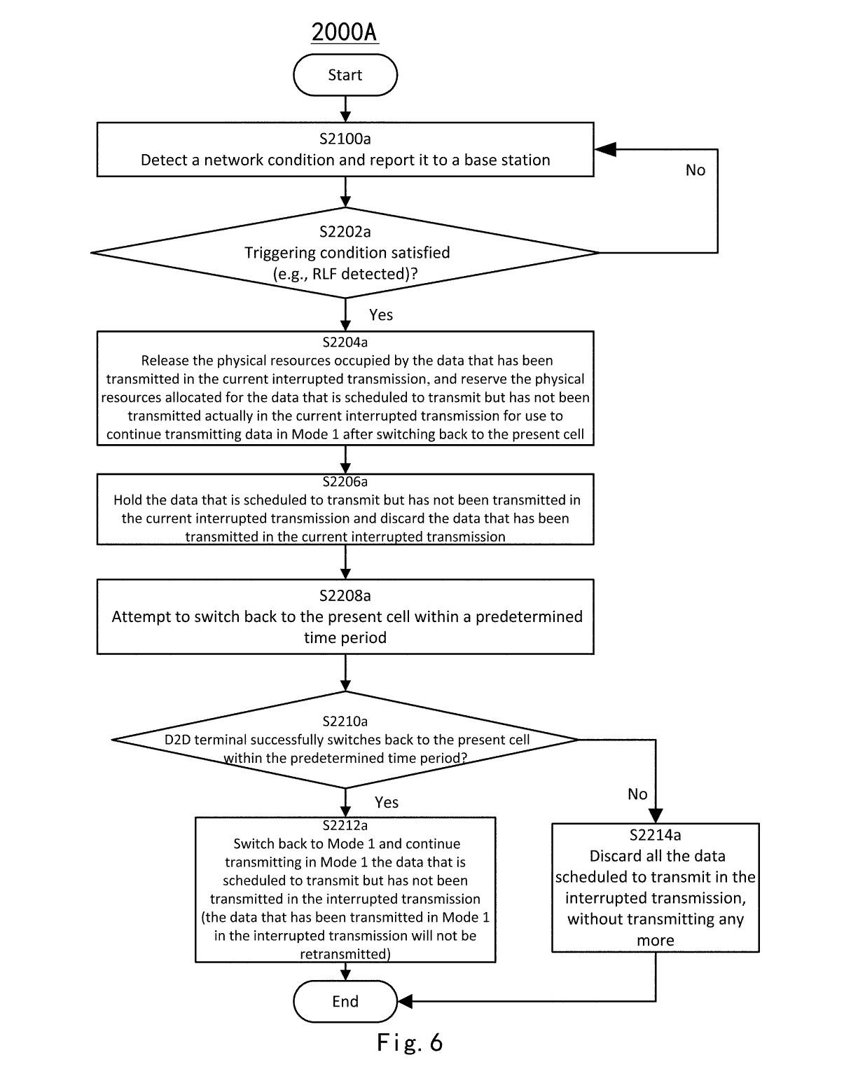

FIG. 6 is a flowchart of an implementation 2000A of the method 2000 according the second embodiment of the present disclosure.

Likewise, the method 2000A starts with a D2D terminal in a Mode 1 transmission. The step S2100a is the same as the step S2100, and the description thereof will be omitted here.

The subsequent parts of the method 2000A describe details of the steps in the Physical Layer Process 2-3.

At step S2202a, the D2D terminal determines whether the detected network condition satisfies a triggering condition of data reception interruption, e.g., whether an RLF has occurred. If the triggering condition is satisfied, the method proceeds with step S2204a; otherwise it returns to step S2100a.

At step S2204a, the D2D terminal releases the physical resources occupied by the data that has been transmitted in the current interrupted schedule and reserves the physical resources allocated for the data that is scheduled to transmit but has not been transmitted actually, for use to continue transmitting the data that is scheduled to transmit but has not been transmitted after switching back to the current cell mode, Mode 1.

At step S2206a, the data that is scheduled to transmit but has not been transmitted in the current interrupted schedule is held, while the data that has been transmitted in the current schedule is discarded.

At step S2208a, an attempt to switch back to the current cell is made within a predetermined time period, if the network allows the terminal to transmit in Mode 2.

At step S2210a, it is determined whether the D2D terminal has successfully switched back to the current cell within the predetermined time period. If so, the method proceeds with step S2212a; otherwise the method proceeds with step S2214a.

At step S2212a, the D2D terminal switches back to Mode 1 and continues transmitting the data that is scheduled to transmit but has not been transmitted in the interrupted schedule in Mode 1 over the previously reserved physical resources allocated for data that is scheduled to transmit but has not been transmitted actually (without retransmitting the data that has been transmitted in Mode 1 before the current schedule was interrupted).

At step S2214a, the D2D terminal discards all the data of the interrupted schedule without transmitting the data any more.

Then, the method 2000A ends.

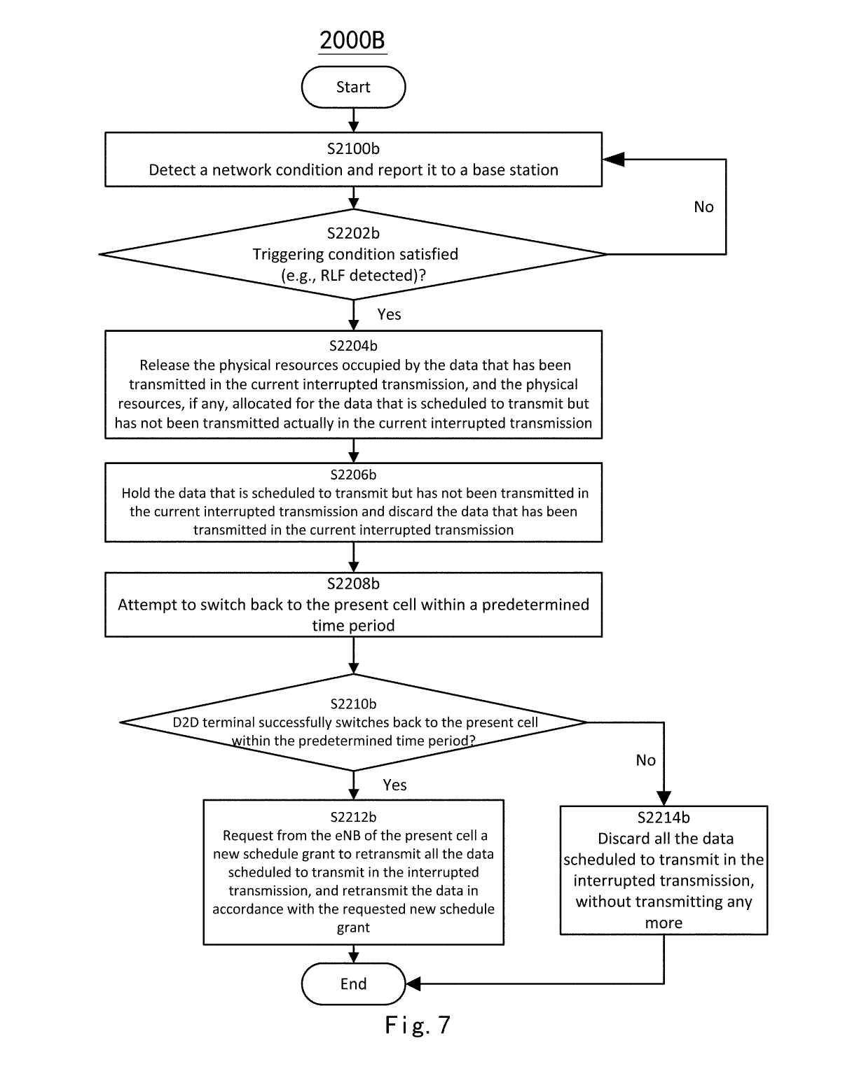

FIG. 7 is a flowchart of another implementation 2000B of the method 2000 according the second embodiment of the present disclosure.

Likewise, the method 2000B starts with a D2D terminal in a Mode 1 transmission. The step S2100b is the same as the step S2100, and the description thereof will be omitted here.

The subsequent parts of the method 2000B describe details of the steps in the Physical Layer Process 2-4.

At step S2202b, the D2D terminal determines whether the detected network condition satisfies a triggering condition of data reception interruption, e.g., whether an RLF has occurred. If the triggering condition is satisfied, the method proceeds with step S2204b; otherwise it returns to step S2100b.

At step S2204b, the physical resources occupied by the data that has been transmitted in the current interrupted schedule, and the physical resources, if any, allocated for the data that is scheduled to transmit but has not been transmitted actually, are released.

At step S2206b, the data that is scheduled to transmit but has not been transmitted in the current interrupted schedule is held, while the data that has been transmitted in the current schedule is discarded.

At step S2208b, an attempt to switch back to the current cell is made within a predetermined time period.

At step S2210b, it is determined whether the D2D terminal has successfully switched back to the current cell within the predetermined time period. If so, the method proceeds with step S2212b; otherwise the method proceeds with step S2214b.

At step S2212b, the D2D terminal switches back to Mode 1 and requests from the network a new grant again to continue transmitting the data that is scheduled to transmit but has not been transmitted in the interrupted schedule (without retransmitting the data that has been transmitted in the interrupted schedule).

At step S2214b, the D2D terminal discards all the data of the interrupted schedule without transmitting the data any more.

Then, the method 2000B ends.

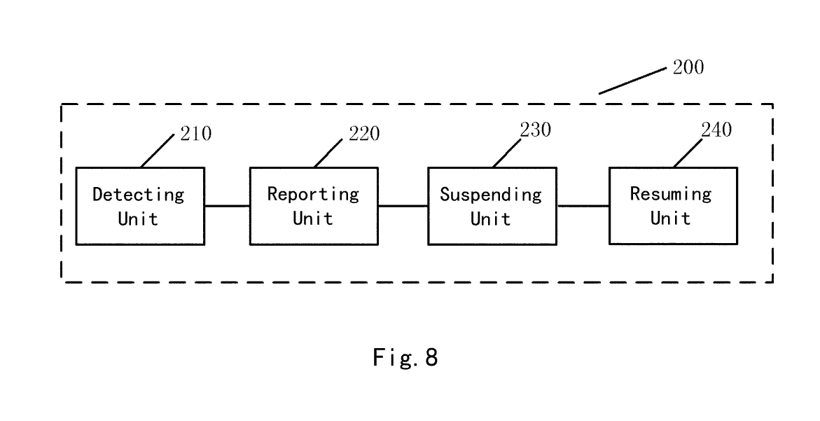

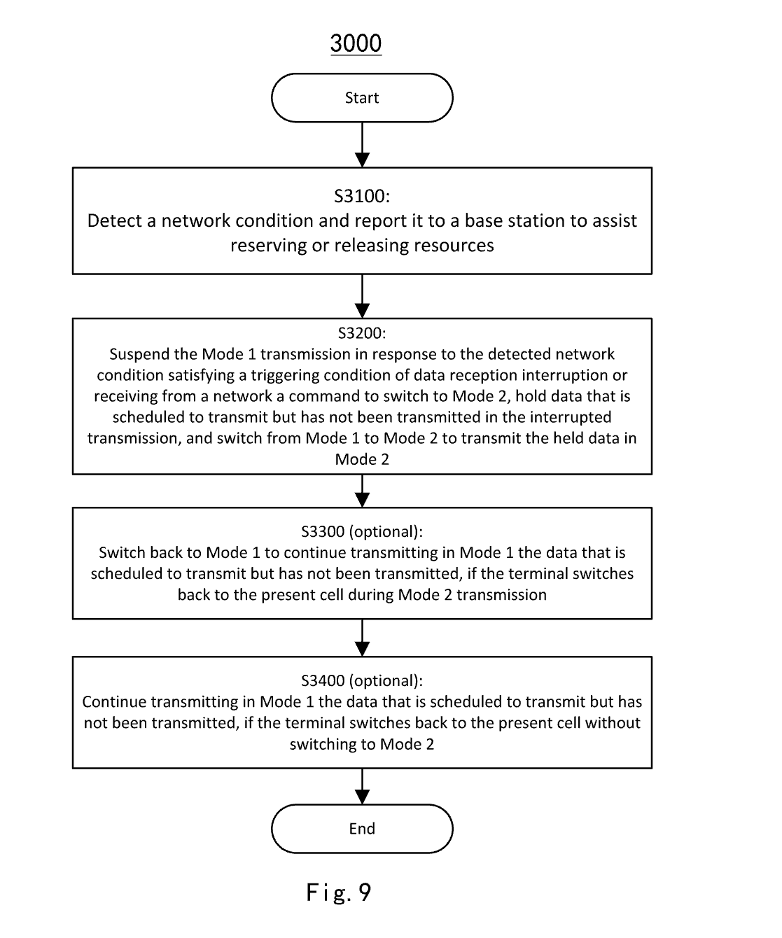

FIG. 8 shows an exemplary D2D terminal 200 according to a second embodiment of the present disclosure. As shown, the terminal 200 may include a detecting unit 210, a reporting unit 220, a suspending unit 230 and a resuming unit 240.

The detecting unit 210 may detect a network condition during a D2D Mode 1 transmission.

The reporting unit 220 may report the detected network condition to a base station to assist the base station in timely releasing physical resources scheduled for the terminal when the transmission is interrupted.

The suspending unit 230 may be configured to hold data that is scheduled to transmit but has not been transmitted in the interrupted transmission in response to the detected network condition satisfying a triggering condition of data reception interruption, and suspend Mode 1 until a successful cell reselection.

The resuming unit 240 may be configured to resume the suspended Mode 1 to continue transmitting the held data that is scheduled to transmit but has not been transmitted in the interrupted transmission when a reselected cell is the same as an original cell accessed by the terminal before a radio link failure.

The D2D terminal 200 may implement the above method 2000 or its implementations 2000A and 2000B with cooperation of the respective components. The detection unit 210 and the reporting unit 220 may be configured to implement the above steps S2100, S2100a or S2100b.

The suspending unit 230 and the resuming unit 240 may implement the operations of the steps S2200 and S2300 in the method 2000, respectively.

Detailed description of the respective components in the D2D terminal 200 will be omitted here.

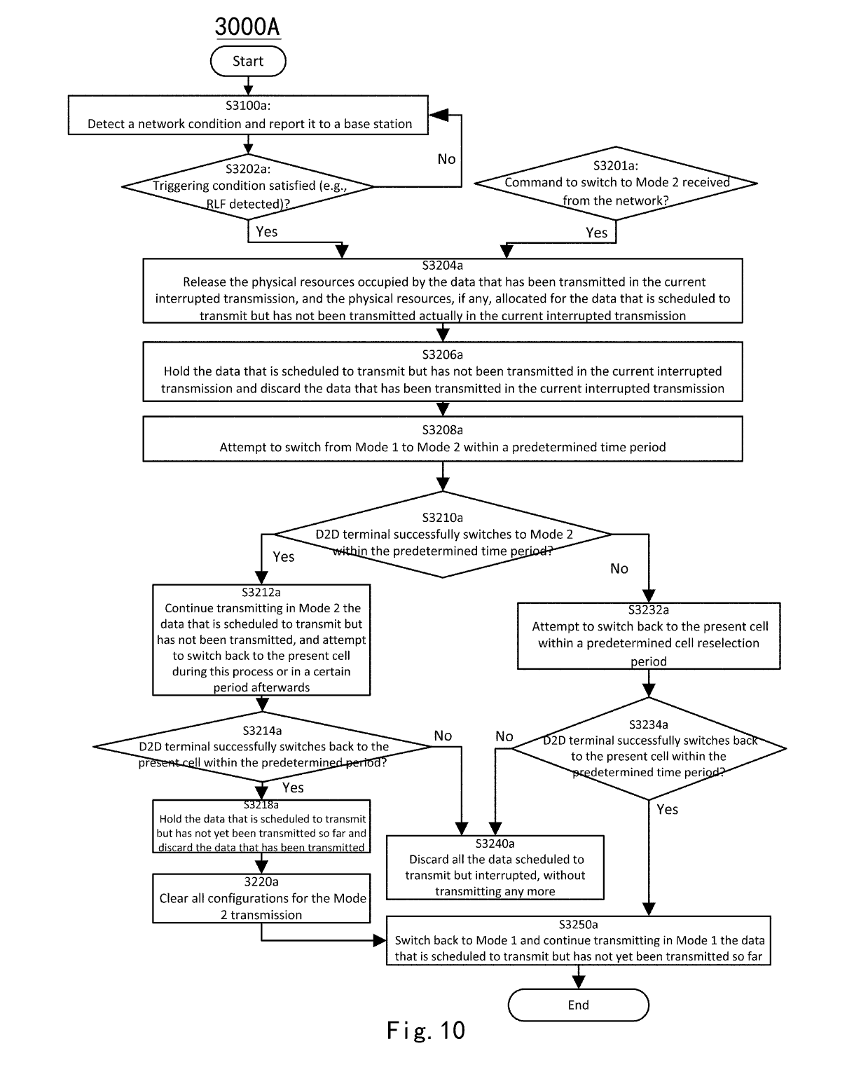

FIG. 10 is a flowchart of a method 3000 according a third embodiment of the present disclosure.

As described above, a D2D communication mode with network scheduling and control, i.e., Mode 1, is typically adopted by a D2D terminal within network coverage. The method 3000 starts with a D2D terminal in a Mode 1 transmission.

At step S3100, the D2D terminal detects a network condition and reports the detected network condition to a base station to assist the base station in timely releasing physical resources scheduled for the terminal when the transmission is interrupted. The step S2100 is similar to the steps S1100 in the method 1000 and details thereof will be omitted here.

At step S3200, the D2D terminal suspends the Mode 1 transmission in response to the detected network condition satisfying a triggering condition of data reception interruption or receiving from a network a command to switch to Mode 2, holds data that is scheduled to transmit but has not been transmitted in the interrupted transmission, and switches from Mode 1 to Mode 2 to transmit in Mode 2 the held data that is scheduled to transmit but has not been transmitted.

Optionally, the method 3000 may further include a step S3300 where the D2D terminal suspends the Mode 2 transmission when a cell reselection occurs during the Mode 2 transmission and a reselected cell is the same as an original cell accessed by the terminal before a radio link failure, holds data that is scheduled to transmit but has not been transmitted in the interrupted Mode 2 transmission, and switches from Mode 2 to Mode 1 to continue transmitting the held data that is scheduled to transmit but has not been transmitted in the interrupted Mode 2 transmission in Mode 1.

Optionally, the method 3000 may further include a step S3400 where the D2D terminal returns to Mode 1 to transmit the held data that is scheduled to transmit but has not been transmitted when the terminal fails to switch from Mode 1 to Mode 2 within a predetermined period and reselects an original cell accessed by the terminal before a radio link failure.

The step S3200 and the optional steps S3300 and S3400 implement the Physical Layer Process 2.

Similarly to the methods 1000 and 2000, the triggering condition of data reception interruption, i.e., the triggering condition of the Physical Layer Process 2, in the step S3200 may be the current network condition indicating that an RLF has occurred. For example, the Physical Layer Process 2 may be triggered after the cell reselection timer T301 or T311 is started. Alternatively, a more radical triggering condition of the Physical Layer Process 2 may be the current network condition indicating that an RLF is about to occur. For example, the Physical Layer Process 2 may be triggered when the cell handover process counter N310 reaches its maximum value and after the timer T310 is started (as shown in FIG. 12-2-a, FIG. 12-2-b, FIG. 12-2-c or FIG. 12-2-d).

The step S3200 and the optional steps S3300 and S3400 may be implemented by the Physical Layer Process 2-5, which will be described in detail below with reference to FIG. 10. Then, the method 3000 ends.

FIG. 10 is a flowchart of an implementation 3000A of the method 3000 according the third embodiment of the present disclosure.

Likewise, the method 3000A starts with a D2D terminal in a Mode 1 transmission. The step S3100a is the same as the step S3100, and the description thereof will be omitted here.

The subsequent parts of the method 3000A describe details of the steps in the Physical Layer Process 2-5.

At step S3202a, the D2D terminal determines whether the detected network condition satisfies a triggering condition of data reception interruption, e.g., whether an RLF has occurred. If the triggering condition is satisfied, the method proceeds with step S3204a; otherwise it returns to step S3100a.

The method also proceeds with step S3204a when a command to switch to Mode 2 is received from the network.

At step S3204a, the physical resources occupied by the data that has been transmitted in the current interrupted schedule, and the physical resources, if any, allocated for the data that is scheduled to transmit but has not been transmitted actually, are released.

At step S3206a, the D2D terminal holds the data that is scheduled to transmit but has not been transmitted in the current interrupted schedule, while discarding the data that has been transmitted in the current schedule.

At step S3208a, if the network allows the terminal to transmit in Mode 2, the terminal attempts to switch back to the current cell within a predetermined time period; otherwise it continues waiting until it enters a predetermined cell reselection period for attempting on cell reselection.

At step S3210a, it is determined whether the D2D terminal has successfully switched to Mode 2 within the predetermined time period. If so, the method proceeds with step S3212a; otherwise the method proceeds with step S3232a where it continues waiting until it enters a predetermined cell reselection period for attempting on cell reselection.

At step S3212a, the D2D terminal switches to Mode 2 and continues transmitting the data that is scheduled to transmit but has not been transmitted in the current interrupted schedule, and attempts to switch back to the current cell during this process or in a certain period afterwards.

At step S3214a, it is determined whether the D2D terminal has successfully switched back to the current cell within the predetermined period while transmitting in Mode 2. The predetermined period for attempting to switch back to the current cell starts when the D2D terminal confirms that the RLF has occurred and attempts to switch from Mode 1 transmission to Mode 2 and its ending time has various configurations. The specific configurations of the predetermined period for attempting to switch back to the current cell will be detailed in the following, with reference to FIGS. 12-1-a to 12-1-d. If the D2D terminal has switched back to the current cell successfully within the predetermined time, the method proceeds with step S3218a; otherwise it proceeds with step S3240a.

At step S3218a, the D2D terminal stops the Mode 2 transmission, holds the data that is scheduled to transmit but has not been transmitted by far in this schedule, discards the data that has been transmitted in this schedule, and clears all the relevant configurations of Mode 2. Then, the method proceeds with step S3250.

At step S3232a, the D2D terminal attempts to switch back to the current cell within a predetermined cell reselection period.

At step S3234a, it is determined whether the D2D terminal has successfully switched back to the current cell within the predetermined time period. If so, the method proceeds with step S3250a; otherwise the method proceeds with step S3240a.

At step S3250a, the D2D terminal switches back to Mode 1 and continues transmitting the data that is scheduled to transmit but has not been transmitted in the current interrupted schedule in Mode 1 (without retransmitting the data that has been transmitted in Mode 1 before the current schedule is interrupted).

At step S3240, the D2D terminal discards all the data of the interrupted schedule without transmitting the data any more.

Then, the method 3000A ends.

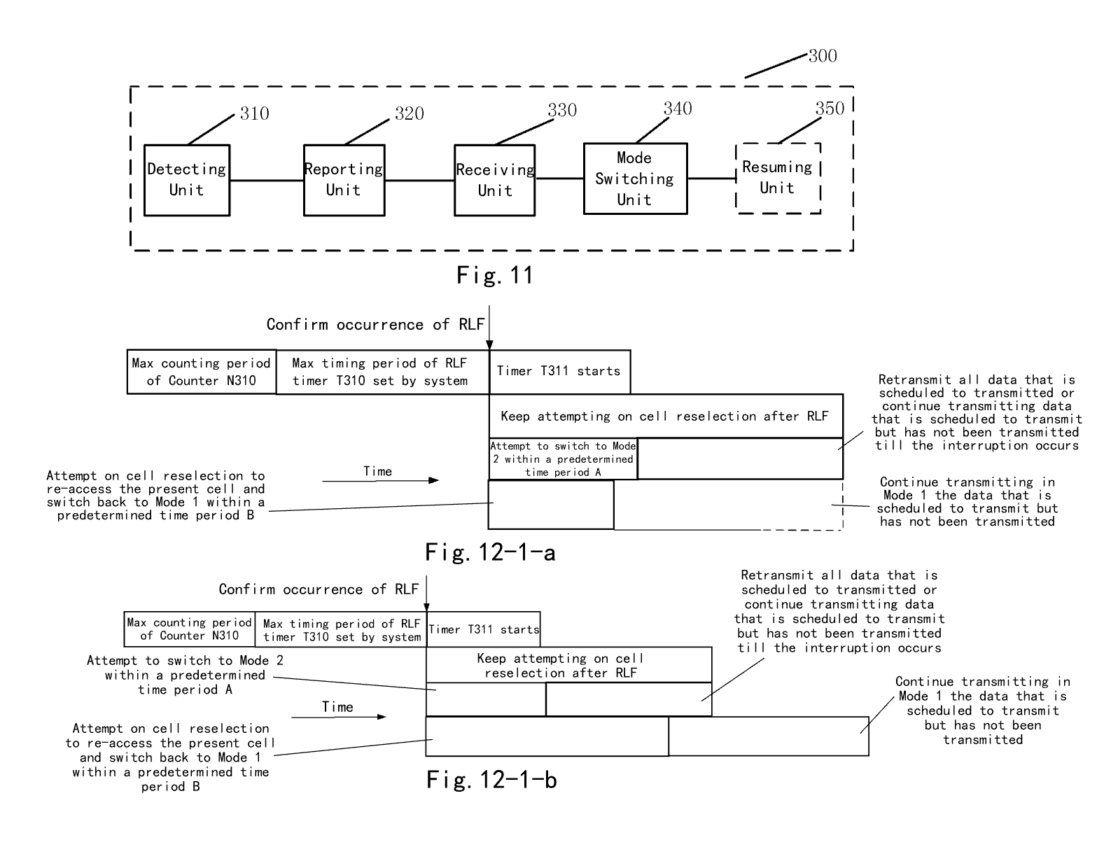

FIG. 11 shows an exemplary D2D terminal 300 according to a third embodiment of the present disclosure. As shown, the terminal 300 may include a detecting unit 310, a reporting unit 320, a receiving unit 330, a mode switching unit 340 and optionally a resuming unit 350.

The detecting unit 310 may detect a network condition during a D2D Mode 1 transmission.

The reporting unit 320 may report the detected network condition to a base station to assist the base station in timely releasing physical resources scheduled for the terminal when the transmission is interrupted.

The receiving unit 330 may receive a command from a network, e.g., a command to switch to Mode 2.

The mode switching unit 340 may be configured to suspend the Mode 1 transmission in response to the detected network condition satisfying a triggering condition of data reception interruption or receiving from a network a command to switch to Mode 2, hold data that is scheduled to transmit but has not been transmitted in the interrupted transmission, attempt to switch to Mode 2 within a predetermined time period A, and switch from Mode 1 to Mode 2 to transmit in Mode 2 the held data that is scheduled to transmit but has not been transmitted. The mode switching unit 340 may further be configured to transmit the held data that is scheduled to transmit but has not been transmitted in Mode 2 after successfully switching to Mode 2.

Optionally, the resuming unit 350 may be configured to perform a cell reselection to attempt to reselect the originally accessed cell and switch back to Mode 1 in a predetermined time period B (the setting of which will be described in detail below) during which it attempts to switch to Mode 2 and successfully switches to Mode 2 to transmit in Mode 2, after the initial Mode 1 transmission was interrupted. The resuming unit 350 suspends the Mode 2 transmission when a cell reselection occurs during the Mode 2 transmission and a reselected cell is the same as an original cell accessed by the terminal before a radio link failure, holds data that is scheduled to transmit but has not been transmitted in the interrupted Mode 2 transmission, and switches from Mode 2 to Mode 1 to continue transmitting the held data that is scheduled to transmit but has not been transmitted in the interrupted Mode 2 transmission in Mode 1.

Optionally, the resuming unit 350 may further be configured to return to Mode 1 to transmit the held data that is scheduled to transmit but has not been transmitted when the terminal fails to switch from Mode 1 to Mode 2 within a predetermined period and reselects an original cell accessed by the terminal before a radio link failure.

There may be various timing relationships between the predetermined time period (i.e., the predetermined time period B) for attempting to switch back to Mode 1 after the initial Mode 1 transmission was interrupted and the predetermined time period (i.e., the predetermined time period A) for attempting to switch back to Mode 2. In the following, the timing relationship between the predetermined time period A and the predetermined time period B will be described in detail with reference to FIGS. 12-1-a to 12-1-d, assuming that the attempts on mode switching or resuming start at the time when the RLF occurs. The predetermined time period B may be set to start at the time when the transmission interruption occurs and have a duration shorter than the predetermined time period A, i.e., to end at a particular time point when the terminal attempts to switch to Mode 2 after the interruption occurs (as shown in FIG. 12-1-a). Alternatively, the predetermined time period B may be set to start at the time when the transmission interruption occurs and have a duration longer than the predetermined time period A and shorter than a sum of a predetermined maximum time period for attempting to switch to Mode 2 and a maximum transmission time in Mode 2, i.e., to end at a particular time point during the Mode 2 transmission after the terminal has successfully switched to Mode 2 (as shown in FIG. 12-1-b). Alternatively, the predetermined time period B may be set to start at the time when the transmission interruption occurs and have a duration equal to a sum of a predetermined maximum time period for attempting to switch to Mode 2 and a maximum transmission time in Mode 2 (as shown in FIG. 12-1-c). Alternatively, the predetermined time period B may be set to start at the time when the transmission interruption occurs and have a duration longer than a sum of a predetermined maximum time period for attempting to switch to Mode 2 and a maximum transmission time in Mode 2 (as shown in FIG. 12-1-d).

Of course, in a more radical triggering condition, the attempts on mode switching or resuming may start at the time when the timer T310 starts. Similar settings are shown in FIGS. 12-2-a, 12-2-b, 12-2-c and 12-2-d.

The D2D terminal 300 may implement the above method 3000 or its implementation 3000A with cooperation of the respective components. The detection unit 210, the reporting unit 220, the mode switching unit 340 and the resuming unit 350 may be configured to implement the respective steps in the method 3000A.

Hence, detailed description of the respective components in the D2D terminal 300 will be omitted here.

While the present disclosure has been described above in conjunction with its preferred embodiments, it may be appreciated by those skilled in the art that the methods and devices shown above are exemplary only. The present disclosure is not limited to the above steps and sequences. The mobile terminal and server according to the present disclosure may include more or less components than those shown above. Various modifications and variants may be made by those skilled in the art, given the teaching of the embodiments.

The devices according to the present disclosure, as well as their components, may be implemented with hardware circuits, e.g., very large integrated circuits or gate arrays, semiconductors such as logic chips and transistors, or programmable hardware devices such as field programmable gate arrays and programmable logic devices, software executed by various processors, or combinations of the above hardware circuits and software.

While the present disclosure has been described above with reference to the particular embodiments, it can be appreciated by those skilled in the art that the scope of the present disclosure is not limited to the above particular embodiments but only defined by the claims as attached and the equivalents thereof.

1. A method in a Device to Device (D2D) communication enabled terminal, comprising:
detecting a network condition during a D2D Mode 1 transmission and reporting the detected network condition to a base station to assist the base station in timely releasing physical resources scheduled for the terminal when the transmission is interrupted; and
holding data scheduled to transmit in the interrupted transmission in response to the detected network condition satisfying a triggering condition of data reception interruption, and switching from Mode 1 to Mode 2 for transmitting the held data in Mode 2.

2. The method of claim 1, wherein the base station releasing physical resources scheduled for the terminal comprises: releasing all of the physical resources scheduled for the interrupted transmission for the terminal when the network condition reported by the terminal satisfies the triggering condition of data reception interruption.

3. The method of claim 1, wherein the triggering condition comprises: the network condition indicating a radio link quality lower than a predetermined criterion or the network condition indicating a radio link failure.

4. The method of claim 1, wherein the held data comprises all the data scheduled to transmit in the interrupted transmission.

5. The method of claim 1, wherein the held data comprises data that is scheduled to transmit but has not been transmitted in the interrupted transmission, but not data that has been transmitted in the interrupted transmission.

6. The method of claim 1, wherein reporting the detected network condition to the base station comprises: reporting to the base station a radio link connection condition between the terminal and the base station, or reporting to the base station a channel measurement value at the terminal.

7. The method of claim 1, wherein reporting the detected network condition to the base station is only performed when the current channel measurement value is lower than a threshold.

8. A method in a Device to Device (D2D) communication enabled terminal, comprising:
detecting a network condition during a D2D Mode 1 transmission and reporting the detected network condition to a base station to assist the base station in timely releasing physical resources scheduled for the terminal when the transmission is interrupted;
holding data that is scheduled to transmit but has not been transmitted in the interrupted transmission in response to the detected network condition satisfying a triggering condition of data reception interruption, and suspending Mode 1 until a successful cell reselection; and
resuming the suspended Mode 1 to continue transmitting the held data that is scheduled to transmit but has not been transmitted in the interrupted transmission when a reselected cell is the same as an original cell accessed by the terminal before a radio link failure.

9. The method of claim 8, wherein physical resources allocated for the data that is scheduled to transmit but has not been transmitted in the interrupted transmission are reserved while Mode 1 is suspended.

10. The method of claim 8, wherein no physical resource allocated for the data that is scheduled to transmit but has not been transmitted in the interrupted transmission is reserved while Mode 1 is suspended, and the method further comprises: requesting resources again while resuming Mode 1 so as to use the newly requested resources to continue transmitting the held data that is scheduled to transmit but has not been transmitted in the interrupted transmission.

11. (canceled)

12. (canceled)

13. (canceled)

14. A Device to Device (D2D) communication enabled terminal, comprising:
a detecting unit configured to detect a network condition during a D2D Mode 1 transmission;
a reporting unit configured to report the detected network condition to a base station to assist the base station in timely releasing physical resources scheduled for the terminal when the transmission is interrupted;
a mode switching unit configured to hold data scheduled to transmit in the interrupted transmission in response to the detected network condition satisfying a triggering condition of data reception interruption, and switch from Mode 1 to Mode 2; and
a data transmitting unit configured to transmit the held data in Mode 2.

15. The terminal of claim 14, wherein the base station releasing physical resources scheduled for the terminal comprises: releasing all of the physical resources scheduled for the interrupted transmission for the terminal when the network condition reported by the terminal satisfies the triggering condition of data reception interruption.

16. The terminal of claim 14, wherein the triggering condition comprises: the network condition indicating a radio link quality lower than a predetermined criterion or the network condition indicating a radio link failure.

17. The terminal of claim 14, wherein the held data comprises all the data scheduled to transmit in the interrupted transmission.

18. The terminal of claim 14, wherein the held data comprises data that is scheduled to transmit but has not been transmitted in the interrupted transmission, but not data that has been transmitted in the interrupted transmission.

19. The terminal of claim 14, wherein said reporting the detected network condition to the base station comprises: reporting to the base station a radio link connection condition between the terminal and the base station, or reporting to the base station a channel measurement value at the terminal.

20. The terminal of claim 14, wherein the reporting unit is further configured to report the detected network condition to the base station only when the current channel measurement value is lower than a threshold.

21. A Device to Device (D2D) communication enabled terminal, comprising:
a detecting unit configured to detect a network condition during a D2D Mode 1 transmission;
a reporting unit configured to report the detected network condition to a base station to assist the base station in timely releasing physical resources scheduled for the terminal when the transmission is interrupted;
a suspending unit configured to hold data that is scheduled to transmit but has not been transmitted in the interrupted transmission in response to the detected network condition satisfying a triggering condition of data reception interruption, and suspend Mode 1 until a successful cell reselection; and
a resuming unit configured to resume the suspended Mode 1 to continue transmitting the held data that is scheduled to transmit but has not been transmitted in the interrupted transmission when a reselected cell is the same as an original cell accessed by the terminal before a radio link failure.

22. The terminal of claim 21, wherein the suspending unit is further configured to reserve physical resources allocated for the data that is scheduled to transmit but has not been transmitted in the interrupted transmission while Mode 1 is suspended.

23. The terminal of claim 21, wherein the suspending unit is further configured to no physical resource allocated for the data that is scheduled to transmit but has not been transmitted in the interrupted transmission while Mode 1 is suspended, and the terminal further comprises a resource requesting unit configured to request resources again while resuming Mode 1 so as to use the newly requested resources to continue transmitting the held data that is scheduled to transmit but has not been transmitted in the interrupted transmission.

24. (canceled)

25. (canceled)

26. (canceled)
